(19) United States
(12) Patent Application Publication
(10) Pub. No.: US 2026/0289387 A1
(43) Pub. Date: Sep. 24, 2026

(54) FEDERATED APPROACHES FOR PERSONALIZED ARTIFICIAL INTELLIGENCE (AI) SOLUTIONS

(71) Applicant: IGT, Las Vegas, NV (US)

(72) Inventors: Soheil Latifi, Brampton (CA); David Small, Moncton (CA); Stefan Keilwert, St. Josef (AT); Michael Russ, Graz (AT)

(21) Appl. No.: 19/083,870

(22) Filed: Mar. 19, 2025

(51) Int. Cl. G06N 20/00; A63F 13/67

(52) U.S. Cl. CPC G06N 20/00; A63F 13/67

(57) ABSTRACT

Embodiments of the present disclosure are directed to applying Artificial Intelligence (AI) to electronic games using models local to an end device which are trained using federated learning. More specifically, embodiments are directed to using federated learning in the context of electronic gaming. Federated learning is the process of deploying a model into an end user’s device and resuming the training process with the user’s data so that there is no data transmitted to the main servers. This process can address the players’ privacy-related concerns by avoiding the sharing or their data with third parties. The federated model can be pre-trained on collected data and then be personalized as it is trained on each end user’s device.

### BACKGROUND

The present disclosure is generally directed to applying Artificial Intelligence (AI) to electronic games and more particularly to applying AI to electronic games using models local to an end device.

The use of Artificial Intelligence (AI) in a wide range of applications continues to accelerate. While AI in various applications provides exciting new functionality and advantages never before imagined, use of AI raises a number of concerns, especially for end users. Among the biggest concerns is that of privacy. While the use of AI can support useful and exciting customizations of a variety of applications for end users, these users are also concerned about the use of their personal information. Additionally, for the providers of software and/or services using AI, training of large, centralized models requires a significant amount of computing resources and can therefore be very expensive.

### BRIEF SUMMARY

Embodiments of the present disclosure are directed to applying Artificial Intelligence (AI) to electronic games using models local to an end device which are trained using federated learning. According to one embodiment, a system can comprise a communications interface, a processor coupled with the communications interface, and a memory coupled with and readable by the processor. The memory can store therein a set of instructions which, when executed by the processor, causes the processor to maintain a trained, federated model defining player behavior related to a plurality of aspects of an electronic game, receive, through the communications interface, from a computing device of a player of the electronic game, a request for the trained, federated model, and in response to the request for the trained, federated model, provide, through the communications interface, the trained, federated model to the computing device of the player of the electronic game.

The instructions can further cause the processor to receive, through the communications interface, from the computing device of the player of the electronic game, a trained weight for an aspect of the plurality of aspects of the electronic game. The trained weight for the aspect of the electronic game can indicate local training of the trained, federated model on the computing device of the player of the electronic game. The instructions can further cause the processor to train the trained, federated model with the trained weight for the aspect of the electronic game received from the computing device of the player of the electronic game.

In some cases, the trained, federated model can comprise a plurality of trained, federated models. For example, the plurality of trained, federated models can comprise models for each of a plurality of different geographic regions. In such cases, the request for the trained, federated model can indicate a current geographic region for the computing device of the player of the electronic game, and providing the trained, federated model to the computing device of the player of the electronic game can further comprise selecting one of the plurality of trained, federated models based on the current geographic region for the computing device of the player of the electronic game. Additionally, or alternatively, the request for the trained, federated model can indicate a selected one of the trained, federated models and providing the trained, federated model to the computing device of the player of the electronic game can comprise providing the selected one of the trained, federated models. Providing the trained, federated model to the computing device of the player of the electronic game can additionally, or alternatively, comprise providing a selected one of the trained, federated models based on a status of the player of the electronic game.

In some cases, the computing device of the player of the electronic game can comprise a plurality of computing devices of the player of the electronic game and providing the trained, federated model to the computing device of the player of the electronic game can comprise providing the trained, federated model to each of the plurality of computing devices of the player of the electronic game. In other cases, providing the trained, federated model to the computing device of the player of the electronic game can comprise providing the trained, federated model to a subset of the plurality of computing devices of the player of the electronic game.

According to another embodiment, a computing device can comprise a communications interface, a processor coupled with the communications interface, and a memory coupled with and readable by the processor. The memory can store therein a set of instructions which, when executed by the processor, causes the processor to request, through the communications interface, a trained, federated model from a federated learning server. The trained, federated model can define player behavior related to a plurality of aspects of an electronic game. The instructions can further cause the processor to receive, through the communications interface, the trained, federated model from the federated learning server, save the received trained, federated model as a local model, apply the local model to the electronic game, monitor activity of a user of the computing device while playing the electronic game, and train the local model based on the monitored activity of the user of the computing device while playing the electronic game. Training the local model based on the monitored activity of the user of the computing device while playing the electronic game can comprise generating a trained weight for an aspect of the plurality of aspect of the electronic game and the instructions further cause the processor to provide, through the communications interface, the trained weight for the aspect of the plurality of aspects of the electronic game to the federated learning server.

In some cases, the instructions can further cause the processor to transfer, through the communications interface, the local model to another computing device of the user. Additionally, or alternatively, the instructions can further cause the processor to synchronize, through the communications interface, the local model with a local model on another computing device of the user. The instructions can additionally, or alternatively, cause the processor to manage the local model based on input from the user of the computing device. For example, managing the local model can comprise any one or more of reversing training of the local model, resetting the local model, retaining the local model on the computing device after play of the electronic game is finished, and/or others.

According to yet another embodiment, a system can comprise a communications network and a federated learning server coupled with the communications network. The federated learning server can comprise a processor and a memory coupled with and readable by the processor of the federated learning server and storing therein a set of instructions which, when executed by the processor of the federated learning server, causes the processor of the federated learning server to maintain a trained, federated model defining player behavior related to a plurality of aspects of an electronic game.

The system can further comprise a computing device coupled with the communications network. The computing device can comprise a processor and a memory coupled with and readable by the processor of the computing device and storing therein a set of instructions which, when executed by the processor of the computing device, causes the processor of the computing device to request the trained, federated model from the federated learning server. For example, the computing device can comprises a gaming system. In some cases, the gaming system can comprise an Electronic Gaming Machine (EGM). In another example, the computing device can comprise a mobile device.

The instructions stored in the memory of the federated learning server can further cause to processor of the federated learning server to receive the request for the trained, federated model from the computing device and in response to the request for the trained, federated model, provide the trained, federated model to the computing device.

The instructions stored in the memory of the computing device can further cause the processor of the computing device to receive the trained, federated model from the federated learning server, save the received trained, federated model as a local model, apply the local model to the electronic game, monitor activity of a user of the computing device while playing the electronic game, and train the local model based on the monitored activity of the user of the computing device while playing the electronic game.

Training the local model based on the monitored activity of the user of the computing device while playing the electronic game can comprise generating a trained weight for an aspect of the plurality of aspect of the electronic game. In such cases, the instructions stored in the memory of the computing device can further cause the processor of the computing device to provide the trained weight for the aspect of the plurality of aspects of the electronic game to the federated learning server. The instructions stored in the memory of the federated learning server can then cause the processor of the federated learning server to receive the trained weight for the aspect of the electronic game from the computing device and train the trained, federated model with the trained weight for the aspect of the electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure may be implemented.

FIG. 2 is a block diagram illustrating additional details of an exemplary federated learning server according to one embodiment of the present disclosure.

FIG. 3 is a block diagram illustrating additional details of an exemplary computing device according to one embodiment of the present disclosure.

FIG. 4 is a flowchart illustrating an exemplary process for applying AI to electronic games using models local to an end device according to one embodiment of the present disclosure.

FIG. 5 is a flowchart illustrating an exemplary process for applying AI to electronic games using models local to an end device according to another embodiment of the present disclosure.

### DETAILED DESCRIPTION

Embodiments of the present disclosure are directed to applying Artificial Intelligence (AI) to electronic games using models local to an end device which are trained using federated learning. More specifically, embodiments are directed to using federated learning in the context of electronic gaming. Federated learning is the process of deploying a model into an end user’s device and resuming the training process with the user’s data so that there is no data transmitted to the main servers. This process can address the players’ privacy-related concerns by avoiding the sharing or their data with third parties. The federated model can be pre-trained on collected data and then be personalized as it is trained on each end user’s device.

Embodiments described herein are not limited to a single solution but can apply to any AI or Machine Learning (ML) solution that is trained on a user’s data. The training process can be scheduled with the user. In one embodiment, the models can be partially trained so the initial training process would only take a few minutes.

The federated approach can be deployed to gaming systems, such as Electronic Gaming Systems (EGMs), cell phones, PCs and other user end devices. The federated approach can maximize local personalization by adapting the model to regional preferences. The models deployed this way can be more efficient, and easier to adapt to change because they are exposed to similar players with common backgrounds.

Embodiments described herein address user data privacy issues. With federated learning, the players can choose which device they want to play on because the devices can be subjected to different forms of data collection. These forms of data collection can entice different players with different privacy concerns to play the game. This form of training and data collection will allow one single model to fit all the tastes, without manually training and deploying.

The need for federated learning is rather obvious, as it lowers the training costs of the models immensely. Embodiments disclosed herein also motivate the players to share their data. This process also indirectly decreases the warehousing costs related to the data.

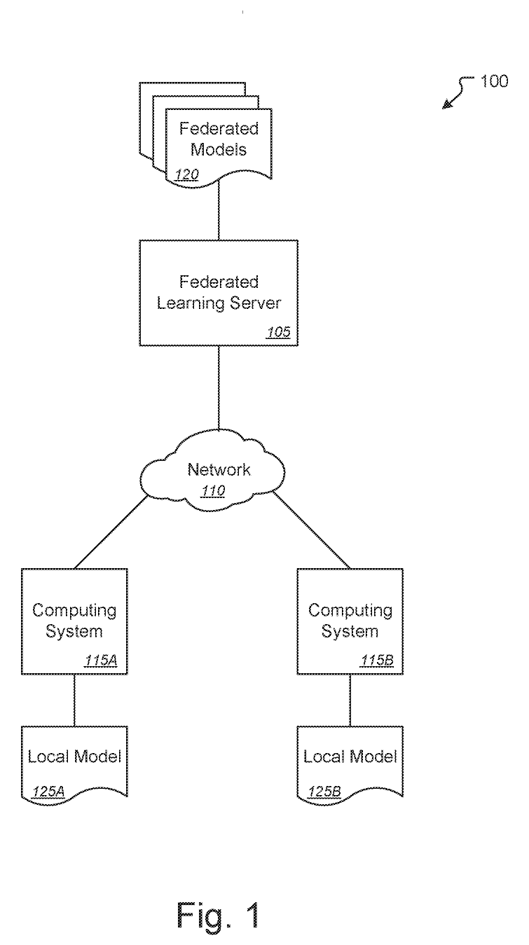

FIG. 1 is a block diagram illustrating an exemplary environment in which embodiments of the present disclosure may be implemented. As illustrated in this example, the environment 100 can comprise a federated learning server 105 coupled with a communications network 110. Generally speaking, the federated learning server 105 can comprise any one or more servers and/or other computing devices as known in the art. The communications network 110 can comprise any one or more wired and/or wireless, local-area and/or wide-area networks as known in the art including, but not limited to, the Internet. Also coupled with the communications network 110 can be any number of computing systems 115A-115B. Generally speaking, each computing system 115 can comprise a personal computer, laptop computer, tablet, smartphone, or similar device. In some cases, one or more of the computing devices can comprise a gaming system such as, for example, any Electronic Gaming Machine (EGM), kiosk, or similar gaming system as may be found in a casino or other gaming venue. Such a gaming system and/or other computing systems 115A-115B can each execute any of a variety of electronic games including, but not limited to slots, video slots, video poker, keno, etc. to be played by any number of players.

Generally speaking, the federated learning server 105 can maintain one or more trained, federated models 120. Each federated model 120 can define player behavior related to a plurality of aspects of an electronic game. A computing device 115A can request the trained, federated model 120 from the federated learning server 105. The federated learning server 105 can receive the request for the trained, federated model 120 from the computing device and in response to the request for the trained, federated model 105, provide the trained, federated model 120 to the computing device 115A. The computing device 115A can receive the trained, federated model 120 from the federated learning server 105, save the received trained, federated model as a local model 125A, apply the local model 125A to the electronic game, monitor activity of a user of the computing device 115A while playing the electronic game, and train the local model 125A based on the monitored activity of the user of the computing device 115A while playing the electronic game. Training the local model 12A based on the monitored activity of the user of the computing device 115A while playing the electronic game can comprise generating a trained weight for an aspect of the plurality of aspect of the electronic game. The computing device to provide the trained weight for the aspect of the plurality of aspects of the electronic game to the federated learning server 105. The federated learning server 105 can then receive the trained weight for the aspect of the electronic game from the computing device 11A and train the trained, federated model 120 with the trained weight for the aspect of the electronic game.

Stated another way, data sources for training the federated models 120 can include, but are not limited to player behavior data of the “owner” of the model and data from other players who are willing to share their data. The data can be collected and managed by the central federated learning server 105 and then shared with end computing devices 115A-115B. This data can have any form depending on the model's needs. The data can be prepared and processed in batches. An instance of the federated model 120 can be transferred to the end computing device 115A. The computing device 115A, when not being otherwise used, can start the training process. The training process can be done with a low learning rate making sure that it stays relevant to the main central instance. Once the training is done the local model can be deleted and the trained weights can be saved. The saved trained weights can be batched and delivered to the federated learning server 105.

According to one embodiment, a custom AI wizard can be created and used to provide player specific advice on how to achieve the optimal experience, based on how each specific player plays as indicated by the local model 125A. The local model 125 could be transferable from game to game and suggest strategies to the player that would give him the best experience for each different type of game he plays.

According to one embodiment, the local model 125 can be used to implement an intelligent auto-play to play the game on the player’s behalf. This feature can include pausing an unusual player selection, based on the local model 125, and asking the player for confirmation if they really want to perform that action. Additionally, or alternatively, the player can ask at any point in time in the gameplay for a proposed action based on the local model.

The resulting recommendation can be based on the player’s previous or usual play behavior, the performance of previous similar actions, i.e., favorable vs. unfavorable actions, or a combination thereof. For example, the recommendation could include proposing “Usually you would perform this action and you were 80% successful with this action in the past.”

According to one embodiment, the players can pick a federated model from a marketplace to use only the models they like. In some cases, free of charge models may be available. In other cases, federated models 105 may be purchased or acquired via a subscription fee. According to one implementation, players may be permitted to pick different models for each computing device the player uses, or they can apply one model across multiple devices.

According to one embodiment, players can reverse the training process to recollect and possibly rest their data at the end of a gaming session. Additionally, or alternatively, players can check what was done with their data and elect to delete the changes they seem necessary. In some cases, players can be presented with an option to select what type of player data should be collected, e.g. granularity, behavioral, etc. A user interface present on the computing device can provide a visual display of the amount of data stored. When the player hits the delete button, the visual display can show that the data file is empty, much in the same way as deleting a file on a computer. Three could also be an “empty the wastebasket” button to further demonstrate to the player that his data is gone. Additionally, or alternatively, the player can be presented with an option to reset the local model, i.e., delete user-related data, and start training from scratch. In some cases, a player can be given an option to store/restore a trained local model to/from a local model history and/or to manage several models, each model for a specific use-case, game, product, etc.

According to one embodiment, the player can be given an option to retain the data locally on his mobile device, so that his model would become more sophisticated and more customized to his specific needs. The player’s custom data would be retained on the end computing device only. In some cases, a responsible gaming feature could also take advantage of this private data retention feature, whereby an AI wizard can track the progress of the player on responsible gaming journey and provide customized suggestions and encouragement to the player as he progresses over time. The privacy aspect of not sharing personal data with anyone would further increase the usage of this tool for players who do not want to be known as a potential “problem gambler.”

In some cases, a player may choose to share some or all personal data with the operator or vendor of a game. This sharing can be in exchange for compensation of some kind, such as some free play, lead user testing of new games, or other casino compensation.

According to one embodiment, the local model 125 can be transferable. For example, the player can be offered the option to move a local model from one device to another. Additionally, or alternatively, the local model can be synchronized across devices, independent of device use.

According to one embodiment, a player having their local model connected to casino play, e.g., through their mobile device, can be made eligible for casino loyalty points collection, even without having their player tracking card inserted. By the fact that someone is playing with their model, the “model loyalty mode” can be activated, granting loyalty points to the model’s “play account.” This can be the same loyalty points as regular players collect or can be a separate “model loyalty points system.” In some cases, having both player tracking and model play active might grant the player both loyalty collection streams.

According to one embodiment, a local model, e.g., stored on player’s mobile device, can be connected to a gaming system such as an EGM, through wired or wireless connection, e.g., Near-Field Technology (NFT), BluTooth, WiFi, etc. By doing so, the gaming system can enable a model play mode and send game state information, including player input, in real-time, to the connected mobile device.

In some cases, and as with player cards, the player can terminate their model play state at any time. In such cases, the model play state can end immediately and the game can continue in a non-model, regular game play. Through such an on-the-fly connection, the player can decide which game actions, states, or events they want to train their model with and which not. For example, the player can decide to only train their bonus game model, or their base-game model, etc. In other cases, the player can decide to only train their model when they place bets over a certain amount or on another certain betting behavior.

According to one embodiment, a player can set a rule-based definition for which data is used to train their models. In some cases, either through their mobile device and/or the gaming system, the player can be given rules and/or criteria for which data is used to train their model. For example, on a mobile device, in an app through which player’s local model can be managed, the play can be presented with a “Settings” button where they can specify model training parameters. Unselected inputs can be ignored. Examples of selectable training parameters can include, but are not limited to theme-specific training, betting-specific training, game-event specific training, and/or others. This functionality can be used by the player to train a model for a specific need or for optimizing their local model on specific events when the player is not satisfied with the model’s prediction performance and wants to train it.

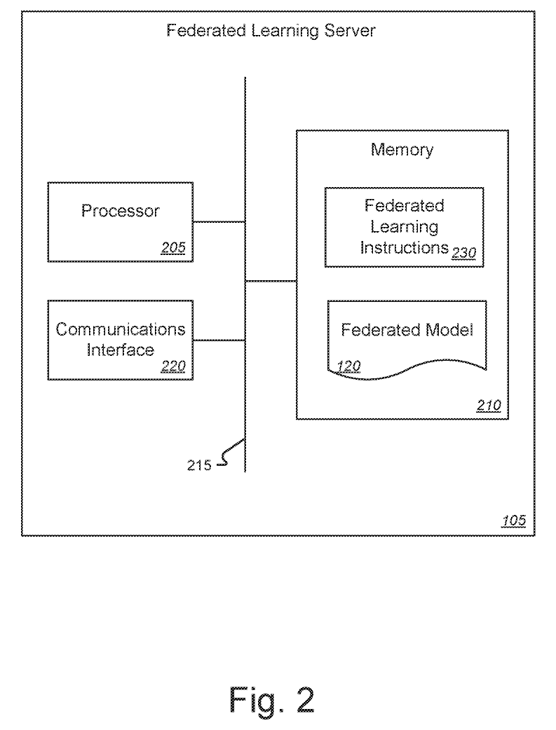

FIG. 2 is a block diagram illustrating additional details of an exemplary federated learning server according to one embodiment of the present disclosure. As illustrated in this example, a federated learning server 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the federated learning server 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the federated learning server 105 can communicate with other devices and/or systems through a communications network 110 as described above.

The memory 210 can store therein a set of federated learning instructions 230 which, when executed by the processor 205, cause the processor 205 to maintain one or more trained, federated models 120. Each federated model 120 can define player behavior related to a plurality of aspects of an electronic game, for example. In some cases, the trained, federated models can comprise a plurality of trained, federated models. For example, the plurality of trained, federated models comprises models for each of a plurality of different geographic regions, users, user types, etc.

The federated learning instructions 230 can further cause the processor 205 to receive, through the communications interface 220 a request for the trained, federated model 120 can be received 410 from a computing device 115, e.g., a gaming system, a mobile device or personal computer of a player of the electronic game, etc. In response to the request, the federated learning instructions 230 can further cause the processor 205 to select a trained, federated model from the trained federated models 120. For example, the request for the trained, federated model can indicate a current geographic region for the computing device 115 of the player of the electronic game, and selecting one of the plurality of trained, federated models 120 can be based on the current geographic region for the computing device 115 of the player of the electronic game. In another example, the request for the trained, federated model can indicate one of the trained, federated models 120 and selecting the trained, federated model can comprise selecting 415 the indicated one of the trained, federated models. In yet another example, selecting one of the trained, federated models 120 can be based on a status of the player of the electronic game. In any such case, the federated learning instructions 230 can further cause the processor 205 to provide, through the communications interface 220, the selected, trained, federated model to the computing device 115 of the player of the electronic game.

In some cases, the computing device 115 of the player of the electronic game can comprise a plurality of computing devices of the player of the electronic game and providing the trained, federated model to the computing device of the player of the electronic game can comprise providing the trained, federated model to each of the plurality of computing devices of the player of the electronic game. In other cases, providing the trained, federated model to the computing device of the player of the electronic game can comprise providing the trained, federated model to a subset of the plurality of computing devices of the player of the electronic game.

At a later point in time, the federated learning instructions 230 can further cause the processor 205 to receive a trained weight for an aspect of the plurality of aspects of the electronic game defined in the provided trained, federated model. The trained weight for the aspect of the electronic game can indicate local training of the trained, federated model on the computing device 115 of the player of the electronic game. The federated learning instructions 230 can further cause the processor 205 to further train the trained, federated model with the trained weight for the aspect of the electronic game received from the computing device 115 of the player of the electronic game.

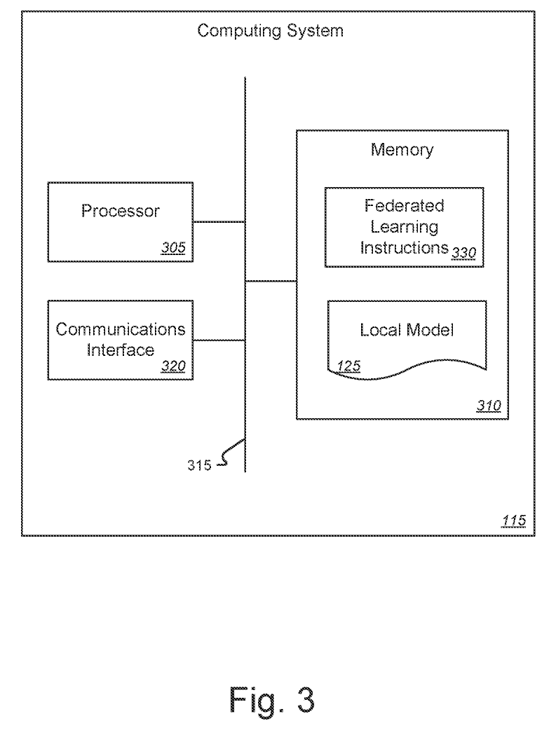

FIG. 3 is a block diagram illustrating additional details of an exemplary computing device according to one embodiment of the present disclosure.

As illustrated in this example, a gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, and a display 325. The communication interfaces 320 can comprise, for example, an Ethernet, Bluetooth, WiFi, cellular, and/or other type of wired and/or wireless communications interface. The display 325 can comprise a Liquid Crystal Display (LCD), Light Emitting Diode (LED), Organic Light Emitting Diode (OLED), or other type of display.

The memory 310 can store therein a set of federated learning instructions 330 which, when executed by the processor 305, causes the processor 305 to request, through the communications interface 320, a trained, federated model 120 from a federated learning server 105. The trained, federated model can define player behavior related to a plurality of aspects of an electronic game. The federated learning instructions 330 can further cause the processor 305 to receive, through the communication interface 320, the trained, federated model 120 from the federated learning server 105 and save the received trained, federated model as a local model 125.

The federated learning instructions 330 can further cause the processor 305 to apply the local model 125 to the electronic game and monitor activity of a user of the computing device 115 while playing the electronic game. The federated learning instructions 330 can further cause the processor 305 to train the local model 125 based on the monitored activity of the user of the computing device while playing the electronic game. Training the local model 125 based on the monitored activity of the user of the computing device 115 while playing the electronic game can comprise generating a trained weight for an aspect of the plurality of aspect of the electronic game. The federated learning instructions 330 can further cause the processor 305 to provide, through the communications interface 320, the trained weight for the aspect of the plurality of aspects of the electronic game to the federated learning server 105.

In some cases, the federated learning instructions 330 can further cause the processor 305 to transfer the local model 125 to and/or synchronize the local model 125 with another computing device of the user. Additionally, or alternatively, the federated learning instructions 330 can further cause the processor 305 to manage the local model 125 based on input from the user of the computing device. For example, managing the local model 125 can comprise reversing training of the local model 125. Additionally, or alternatively, managing the local model 125 can comprise resetting the local model 125, i.e., to a default or previous state. Managing the local model 125 can additionally, or alternatively, comprise optionally retaining the local model 125 on the computing device 115 after play of the electronic game is finished.

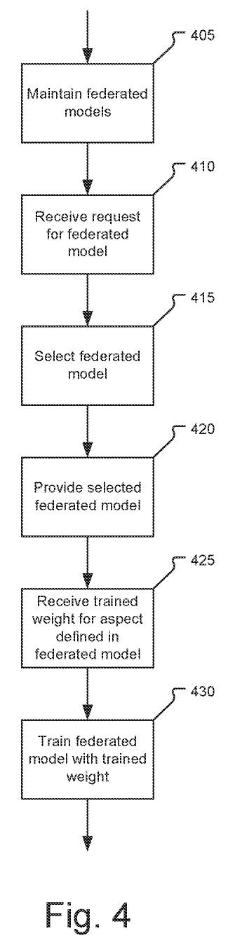

FIG. 4 is a flowchart illustrating an exemplary process for applying AI to electronic games using models local to an end device according to one embodiment of the present disclosure. More specifically, this example illustrates processes as may be performed by a federated learning server 105 as described above. As illustrated in this example, processing may begin with maintaining 405 one or more trained, federated models 120. Each federated model 120 can define player behavior related to a plurality of aspects of an electronic game, for example. In some cases, the trained, federated models can comprise a plurality of trained, federated models. For example, the plurality of trained, federated models comprises models for each of a plurality of different geographic regions, users, user types, etc.

A request for the trained, federated model 120 can be received 410 from a computing device 115, e.g., a gaming system, a mobile device or personal computer of a player of the electronic game, etc. In response to the request, the trained, federated model, can be selected 415 from the trained federated models 120. For example, the request for the trained, federated model can indicate a current geographic region for the computing device 115 of the player of the electronic game, and selecting 415 one of the plurality of trained, federated models 120 can be based on the current geographic region for the computing device 115 of the player of the electronic game. In another example, the request for the trained, federated model can indicate one of the trained, federated models 120 and selecting 415 the trained, federated model can comprise selecting 415 the indicated one of the trained, federated models. In yet another example, selecting 415 one of the trained, federated models 120 can be based on a status of the player of the electronic game. In any such case, the selected, trained, federated model can be provided 420 to the computing device 115 of the player of the electronic game.

In some cases, the computing device 115 of the player of the electronic game can comprise a plurality of computing devices of the player of the electronic game and providing 420 the trained, federated model to the computing device of the player of the electronic game can comprise providing 420 the trained, federated model to each of the plurality of computing devices of the player of the electronic game. In other cases, providing 420 the trained, federated model to the computing device of the player of the electronic game can comprise providing the trained, federated model to a subset of the plurality of computing devices of the player of the electronic game.

At a later point in time, a trained weight for an aspect of the plurality of aspects of the electronic game defined in the provided 420 trained, federated model can be received 425. The trained weight for the aspect of the electronic game can indicate local training of the trained, federated model on the computing device 115 of the player of the electronic game. The trained, federated model can then be further trained 430 with the trained weight for the aspect of the electronic game received from the computing device 115 of the player of the electronic game.

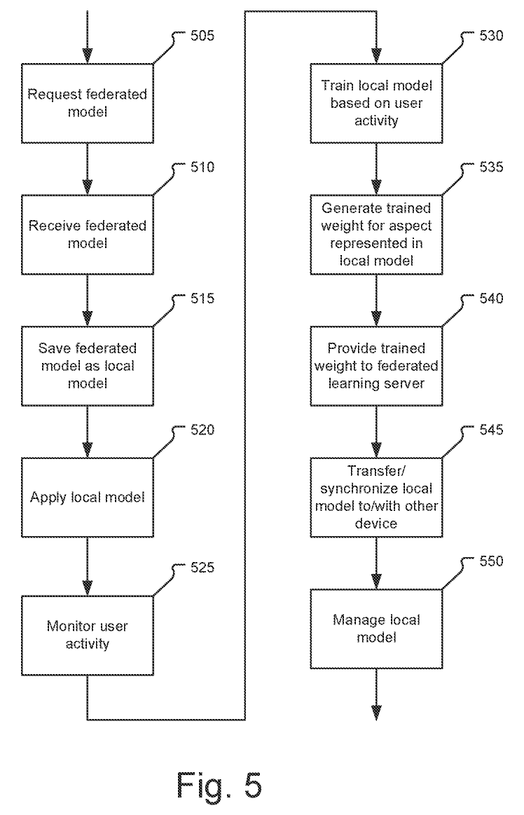

FIG. 5 is a flowchart illustrating an exemplary process for applying AI to electronic games using models local to an end device according to another embodiment of the present disclosure. More specifically, this example illustrates processes as may be performed by a computing system 115 as described above. As illustrated in this example, processing may begin with requesting 505 a trained, federated model 120 from a federated learning server 105. The trained, federated model can define player behavior related to a plurality of aspects of an electronic game. The trained, federated model 120 can be received 510 from the federated learning server 105 and saved 515 as a local model 125.

The local model 125 can be applied 520 to the electronic game and activity of a user of the computing device 115 can be monitored 525 while playing the electronic game. The local model 125 can be trained 530 based on the monitored 125 activity of the user of the computing device while playing the electronic game. Training 530 the local model 125 based on the monitored activity of the user of the computing device 115 while playing the electronic game can comprise generating 535 a trained weight for an aspect of the plurality of aspect of the electronic game. The trained weight for the aspect of the plurality of aspects of the electronic game can be provided 540 to the federated learning server.

In some cases, the local model 125 can be transferred to and/or synchronized 545 with another computing device of the user. Additionally, or alternatively, the local model 125 can be managed 550 based on input from the user of the computing device. For example, managing 550 the local model 125 can comprise reversing training of the local model 125. Additionally, or alternatively, managing 550 the local model 125 can comprise resetting the local model 125, i.e., to a default or previous state. Managing 550 the local model 125 can additionally, or alternatively, comprise optionally retaining the local model 125 on the computing device 115 after play of the electronic game is finished.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer-readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A system comprising:
a communications interface;
a processor coupled with the communications interface; and
a memory coupled with and readable by the processor and storing therein a set of instructions which, when executed by the processor, causes the processor to:
maintain a trained, federated model defining player behavior related to a plurality of aspects of an electronic game;
receive, through the communications interface, from a computing device of a player of the electronic game, a request for the trained, federated model;
in response to the request for the trained, federated model, provide, through the communications interface, the trained, federated model to the computing device of the player of the electronic game;
receive, through the communications interface, from the computing device of the player of the electronic game, a trained weight for an aspect of the plurality of aspects of the electronic game, wherein the trained weight for the aspect of the electronic game indicates local training of the trained, federated model on the computing device of the player of the electronic game; and
train the trained, federated model with the trained weight for the aspect of the electronic game received from the computing device of the player of the electronic game.

2. The system of claim 1, wherein the trained, federated model comprises a plurality of trained, federated models.

3. The system of claim 2, wherein the plurality of trained, federated models comprises models for each of a plurality of different geographic regions, wherein the request for the trained, federated model indicates a current geographic region for the computing device of the player of the electronic game, and wherein providing the trained, federated model to the computing device of the player of the electronic game further comprises selecting one of the plurality of trained, federated models based on the current geographic region for the computing device of the player of the electronic game.

4. The system of claim 2, wherein the request for the trained, federated model indicates a selected one of the trained, federated models and wherein providing the trained, federated model to the computing device of the player of the electronic game comprises providing the selected one of the trained, federated models.

5. The system of claim 2, wherein providing the trained, federated model to the computing device of the player of the electronic game comprises providing a selected one of the trained, federated models based on a status of the player of the electronic game.

6. The system of claim 1, wherein the computing device of the player of the electronic game comprises a plurality of computing devices of the player of the electronic game and wherein providing the trained, federated model to the computing device of the player of the electronic game comprises providing the trained, federated model to each of the plurality of computing devices of the player of the electronic game.

7. The system of claim 1, wherein the computing device of the player of the electronic game comprises a plurality of computing devices of the player of the electronic game and wherein providing the trained, federated model to the computing device of the player of the electronic game comprises providing the trained, federated model to a subset of the plurality of computing devices of the player of the electronic game.

8. A computing device comprising:
a communications interface;
a processor coupled with the communications interface; and
a memory coupled with and readable by the processor and storing therein a set of instructions which, when executed by the processor, causes the processor to:
request, through the communications interface, a trained, federated model from a federated learning server, the trained, federated model defining player behavior related to a plurality of aspects of an electronic game;
receive, through the communications interface, the trained, federated model from the federated learning server;
save the received trained, federated model as a local model;
apply the local model to the electronic game;
monitor activity of a user of the computing device while playing the electronic game; and
train the local model based on the monitored activity of the user of the computing device while playing the electronic game.

9. The computing device of claim 8, wherein training the local model based on the monitored activity of the user of the computing device while playing the electronic game comprises generating a trained weight for an aspect of the plurality of aspect of the electronic game and wherein the instructions further cause the processor to provide, through the communications interface, the trained weight for the aspect of the plurality of aspects of the electronic game to the federated learning server.

10. The computing device of claim 8, wherein the instructions further cause the processor to transfer, through the communications interface, the local model to another computing device of the user.

11. The computing device of claim 8, wherein the instructions further cause the processor to synchronize, through the communications interface, the local model with a local model on another computing device of the user.

12. The computing device of claim 8, wherein the instructions further cause the processor to manage the local model based on input from the user of the computing device.

13. The computing device of claim 12, wherein managing the local model comprises reversing training of the local model.

14. The computing device of claim 12, wherein managing the local model comprises resetting the local model.

15. The computing device of claim 12, wherein managing the local model comprises retaining the local model on the computing device after play of the electronic game is finished.

16. A system comprising:
a communications network;
a federated learning server coupled with the communications network, the federated learning server comprising a processor and a memory coupled with and readable by the processor of the federated learning server and storing therein a set of instructions which, when executed by the processor of the federated learning server, causes the processor of the federated learning server to maintain a trained, federated model defining player behavior related to a plurality of aspects of an electronic game; and
a computing device coupled with the communications network, the computing device comprising a processor and a memory coupled with and readable by the processor of the computing device and storing therein a set of instructions which, when executed by the processor of the computing device, causes the processor of the computing device to request the trained, federated model from the federated learning server, wherein:
the instructions stored in the memory of the federated learning server further cause to processor of the federated learning server to receive the request for the trained, federated model from the computing device and in response to the request for the trained, federated model, provide the trained, federated model to the computing device, and
the instructions stored in the memory of the computing device further cause to processor of the computing device to receive the trained, federated model from the federated learning server, save the received trained, federated model as a local model, apply the local model to the electronic game, monitor activity of a user of the computing device while playing the electronic game, and train the local model based on the monitored activity of the user of the computing device while playing the electronic game.

17. The system of claim 16, wherein training the local model based on the monitored activity of the user of the computing device while playing the electronic game comprises generating a trained weight for an aspect of the plurality of aspect of the electronic game, wherein the instructions stored in the memory of the computing device further cause the processor of the computing device to provide the trained weight for the aspect of the plurality of aspects of the electronic game to the federated learning server, and wherein the instructions stored in the memory of the federated learning server cause the processor of the federated learning server to receive the trained weight for the aspect of the electronic game from the computing device and train the trained, federated model with the trained weight for the aspect of the electronic game.

18. The system of claim 16, wherein the computing device comprises a gaming system.

19. The system of claim 18, wherein the gaming system comprises an Electronic Gaming Machine (EGM).

20. The system of claim 16, wherein the computing device comprises a mobile device.
